(19) United States
(12) Patent Application Publication
(10) Pub. No.: US 2012/0224449 A1
(43) Pub. Date: Sep. 6, 2012

(54) BARREL MIXER ANGLE ADJUSTER

(76) Inventor: Eric Harris, Cornwall (GB)

(21) Appl. No.: 13/038,485

(22) Filed: Mar. 2, 2011

(51) Int. Cl. B28C 5/00

(52) U.S. Cl. 366/2; 366/26

(57) ABSTRACT

Typical barrel mixers (10), of the type which may be disassembled for transportation purposes, allow for the barrel (20) to be moved from a mixing position to a tipping position but do not allow for fixing the barrel at positions in between. The present invention provides an adjuster (200, 400) which allows the mixing position to be fixed at selected points between the mixing and tipping positions.

### FIELD OF THE INVENTION

The present invention relates to a barrel mixer adjuster and a barrel mixer including such an adjuster.

### BACKGROUND OF THE INVENTION

Barrel mixers are known for mixing materials. Such barrel mixers are typically used commercially in the construction industry and by private individuals undertaking construction work. The mixers are used to mix materials such as cement, concrete, mortar, render and other similar materials. In particular, such mixers are good for mixing together more than one ingredient, such as sand and cement to make mortar. The mixers may be used either to produce batches of mixed material, in that the mixer is completely emptied between one batch and the next, or may be used to produce continuous amounts of mixed material in that fresh ingredients many be added as necessary and mixed material removed as necessary.

Barrel mixers are manufactured in several different designs. One of the available designs has a barrel mounted such that it can be moved between a mixing position and a tipping position. It also has the facility that the angle of the barrel may be fixed at other positions between the mixing and tipping positions. However, this type of barrel mixer is provided on, and attached to, a base, which may include wheels, and has a relatively large support structure. Due to its size and the attachment of the barrel to the support structure this type of barrel mixer is not readily portable in that it cannot readily be dismantled or disassembled such that it may fit into a typical car.

By contrast, there is another type of barrel mixer available which has a barrel mounted on a frame and a base removably attachable to the frame. This allows for the mixer to be disassembled, at least partially. This aids carrying of the mixer in that it can be disassembled into a size which may fit into in a typical car. However, a problem with this barrel mixer, which is subject to disassembly, is that it is not possible to adjust the angle of the barrel during mixing.

It is advantageous to be able to adjust the angle of the barrel to vary it for different types of mixes. For instance, for relatively wet mixes, it is useful to be able to tilt the barrel back such that the mouth of the barrel is pointed “upwards”. By contrast, for a more dry mix it is useful to be able to adjust the angle such that the mouth of the barrel is pointed more towards the horizontal (in other words “downwards” by comparison with that for wet mixes). In the former case, the angle maintains the wet mix within the barrel rather than it potentially slopping out. In the latter case, the angle allows for the material to be mixed more evenly by the blades which are provided on the internal sides of the barrel.

To adjust the angle of the barrel it is known for people in the construction industry to put chocks under some of the legs of the base. This is frequently achieved by using scaffolding boards. However, these are typically several metres in length and thus provide a tripping hazard around the mixer. Alternatively, other means are provided, such as blocks or bricks under each leg, then, although the trip hazard is alleviated, the mixer becomes unstable such that it is not unknown that when the barrel is moved from the mixing position to the tipping position, the whole structure, barrel mixer, frame and base, tip over. This is dangerous, a waste of material which is shed onto the ground and potentially environmentally damaging.

### BRIEF SUMMARY OF THE INVENTION

Accordingly, it is an object of the present invention to provide an adjuster for adjusting the angle of the barrel of a portable barrel mixer without destabilising it or providing a trip hazard.

In one aspect, the invention provides a barrel mixer comprising a barrel mounted on a frame, a base for supporting the frame, the frame being removably attachable to the base, a motor for rotating the barrel about a rotation axis for mixing of the contents of the barrel, a pivot for allowing movement of the barrel, relative to the base, between a mixing position and a tipping position, wherein the barrel mixer further comprises at least one adjuster for adjustably fixing the position of the barrel at selected points between the mixing and tipping positions.

The motor may be driven by any means such as electrically, hydraulically, pneumatically, hand-powered, or by an internal combustion engine.

The selected points may at any point between the two positions.

The frame may be pivotably attachable to the base. This may allow for a wheel barrow or other receptacle to be placed at any position around the mixer such that the barrel and frame may be rotated around the base so that the mouth of the barrel is directly above the receptacle. Tipping of the barrel then discharges the mixed material into the receptacle for transport to the intended destination.

The frame may include a support member and the frame may be at least partially pivotable about the support member between the mixing and tipping positions. The support member may be located substantially underneath the barrel and between two side arms of the frame. The support may include a connector for connection to the base. For example, the support may include a pintle which fits into a socket provided on the base.

The movement of the frame about the support member may be limited by at least one stop member. One stop member may be provided to limit the movement of the barrel in a direction away from the mixing position and towards the tipping position. One stop member may be provided to limit the movement of the barrel in a direction away from the tipping position and towards the mixing position such that the barrel is maintained in a relatively fixed position, relative to the ground surface, for mixing. Two pairs of stop members may be provided, both pairs having one located at either end of the support member for limiting the movement of the frame.

The at least one adjuster may comprise at least one cam surface and a controller for moving the at least one cam surface between an active position and an inactive position. In an active position the at least one cam surface may lie between the at least one stop member and the frame such that a distance between the at least one stop member and the frame is substantially maintainable with the barrel in the mixing position. In other words, the cam surface may act as the surface on which the frame rests with the barrel in the mixing position. This may allow for the angle of the barrel to be tilted relative to an angle without the use of the cam.

The controller may be a tab, arm, or other such member which allows the adjuster to be moved relative to the mixer.

The at least one adjuster may comprise at least two different cam surfaces, having different dimensions from one another. In an active position any one of the at least two cam surfaces may lie between the stop member and the frame such that the distance between the stop member and the frame, with the barrel in the mixing position, is substantially maintainable dependent on which of the at least two cam surfaces is in the active position. In other words, a user may select from two cam surfaces such that the distance between the frame and stop member is dependent on which cam surface is brought into the active position. This allows for the angle of the barrel to be chosen to suit the mixing requirements.

The at least one cam surface may be provided on a cam carrier. The cam carrier may be slidably receivable in a retaining member. The retaining member may be mounted on one of the support member and the frame. In one embodiment, the cam carrier may be a bolt-like member and the retaining member may be a bolt housing. In this respect, the term “bolt” and “bolt housing” refer to a typical door locking type of bolt. The cams may be provided in the form of projections on the linear side of the bolt.

The at least one cam surface may be movable from the active position to the inactive position by means of sliding the cam carrier relative to the retaining member. This is similar to the action of drawing a bolt.

The at least one cam surface may be provided by an ovoid member which is at least partially rotatable such that, in an active position, the distance between the stop member and the frame is adjustably maintainable with the barrel in the mixing position.

The distance maintainable between the frame and stop member with the barrel in the mixing position may lie in the range 1 mm to 25 mm. More particularly it may lie in the range 5 mm to 15 mm. Preferably, it may be either 8 mm or 15 mm.

The base of the barrel mixer may be configured for disassembly and for fitting inside the drum when disassembled. The base may comprise a set of relatively slender legs.

In another aspect the invention provides a barrel mixer adjuster for use with a barrel mixer of the type comprising a barrel mounted on a frame, a base for supporting the frame, a motor for rotating the barrel about a rotation axis for mixing of the contents of the barrel, a pivot for allowing movement of the barrel, relative to the base, between a mixing position and a tipping position, wherein the adjuster, in use, adjustably maintains the position of the barrel at selected points between the mixing and tipping positions.

The adjuster may be retro-fitted to an existing barrel mixer which was manufactured without such a way of adjustably fixing the angle of the barrel between the tipping and mixing positions.

The adjuster may include an attachment for removably fixing the adjuster to a barrel mixer. For example, the attachment may comprise a clamp for clamping about a part of the barrel mixer. The clamp may clamp around the support member discussed above. Alternatively, the attachment may be suitable for attaching the adjuster to the frame.

In yet another aspect, the invention provides a method of adjustably fixing the position of a barrel of a barrel mixer at selected points between a mixing position and a tipping position comprising the steps of: providing a barrel mixer of the type comprising a barrel mounted on a frame, a base for supporting the frame, a motor for rotating the barrel about a rotation axis for mixing of the barrel contents, a pivot for allowing movement of the barrel, relative to the base; providing an adjuster mounted, or for mounting, on the barrel mixer; operating the adjuster to adjustably fix the position of the barrel at selected points between the mixing position and the tipping position.

### BRIEF DESCRIPTION OF THE DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a view of a known barrel mixer with the barrel in the mixing position;

FIG. 2 is a view of the barrel mixer of FIG. 1 in the tipping position;

FIG. 3 is a view of the pivot assembly of the barrel mixer of FIG. 1;

FIG. 4 is a close-up view of the assembly of FIG. 3;

FIG. 5 is a view of the adjuster according to one embodiment of the present invention fitted to a barrel mixer;

FIG. 6 is a view of the adjuster of FIG. 5;

FIG. 7 is an alternative view of the adjuster of FIG. 5;

FIG. 8 is a view of the adjuster according to another embodiment of the present invention;

FIG. 9 is an alternative view of the adjuster of FIG. 8, in an inactive position; and

FIG. 10 is a view of the adjuster of FIG. 8 in an active position.

### DETAILED DESCRIPTION OF THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may refer to different embodiments. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

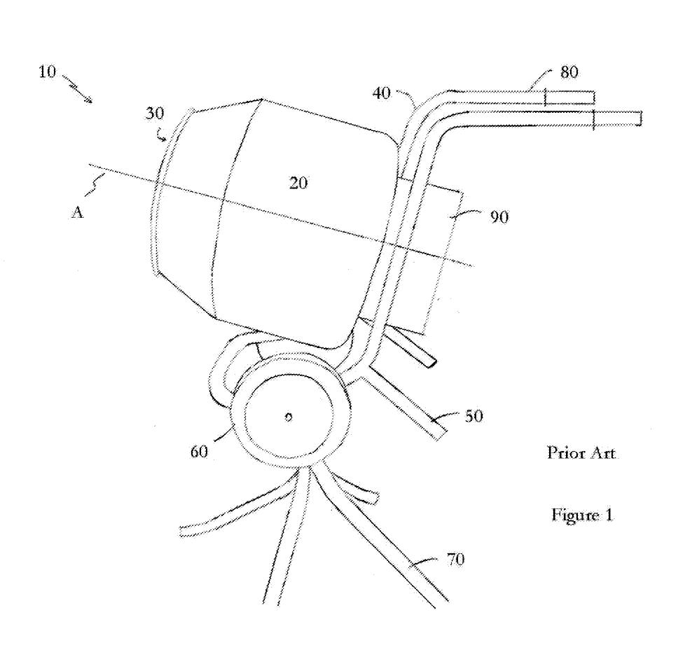

In FIG. 1 a known barrel mixer is generally indicated 10. The mixer 10 comprises a barrel 20 which has an open mouth 30 at one end. The barrel is mounted onto a frame 40 and may rotate about a rotation axis indicated “A”. Rotation of the barrel is effected by a motor 90.

The frame 40 has legs 50 and wheels 60 on which it may rest directly on the ground (not shown). Alternatively, and as shown in FIG. 1, the frame 40 may be supported by a base 70 which comprises four relatively slender legs. The legs may be separable from one another and from the frame 40 to allow for disassembly of the mixer 10 for transportation purposes. The frame 40 may be rotatable relative to the base 70 about a substantially vertical axis. This allows for a wheel barrow or other receptacle to be brought adjacent to the barrel mixer at any point for loading. Not all of the legs 70 are visible in FIG. 1. The frame 40 includes handles 80 for manipulation of the barrel mixer.

The barrel is shown in FIG. 1 in the mixing position. In other words, with the barrel in this position its contents may be retained within the barrel for mixing as the barrel rotates.

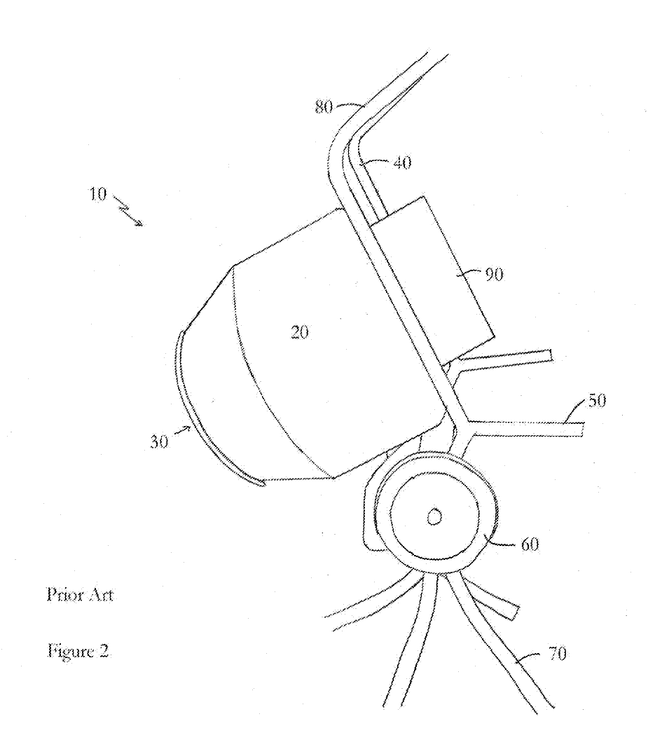

In FIG. 2, the barrel mixer of FIG. 1 is shown in the tipping position. To reach this position the frame 40 has been rotated relative to the legs 70 about a substantially horizontal axis which may be the axis of rotation for the wheels 60. In this position the contents of the barrel 20 may be discharged into a wheelbarrow or other suitable receptacle via the open mouth 30. Not all of the handles 80 and legs 70 are visible in this Figure.

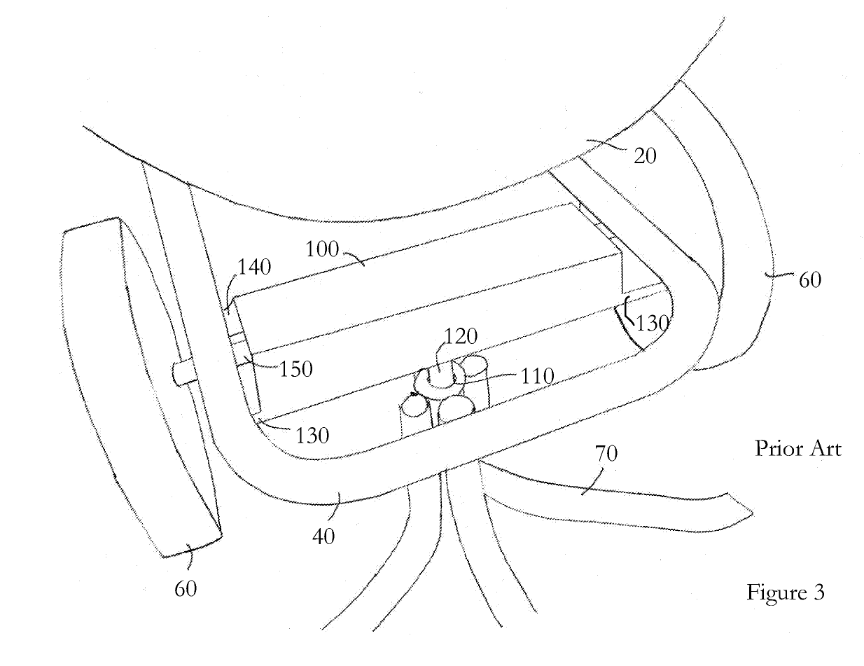

In FIG. 3 the means by which the barrel may be rotated relative to the legs 70 is shown. This is a support member 100 which is a box-like arrangement. It includes a pintle 120 in the centre of the underside for being received in a socket 110 which is arranged at the top of the legs 70. The pintle 120/socket 110 allow for rotation of the frame 40 about a substantially vertical axis relative to the legs 70 and passing through the pintle 120/socket 110. The support member 100 carries an axle 150 which supports a wheel 60 at either end. The wheels 60 may rotate independently of the axle and/or the support member 100. The axle 150 lies substantially parallel to the ground and/or horizontally. The frame 40 is rotatably connected to the axle 150 so that it may rotate relative to the support member 100. The rotatable connection may be an annulus (refer to reference 155 in FIG. 9 for an example) which fits around the axle 150.

The rotation of the frame 40 about the axis 150 allows the barrel 20 to move from a mixing position to a tipping position. The movement of the barrel 20 and frame 40 relative to the legs 70 and support member 100 is limited by stop members 130, 140. The stop members 130 limit the movement of the barrel 20 and frame 40 in one direction about the axle 150 and define the tipping position. In other words, the frame 40 will come to rest against the stop member 130 when tipped forwards from the mixing position to the tipping position. The stop member 140 limits the movement of the barrel 20 and frame 40 in the other direction about the axle 150 and defines the mixing position. In other words, the frame 40 will come to rest against the stop member 140 when tipped backwards from the tipping position to the mixing position.

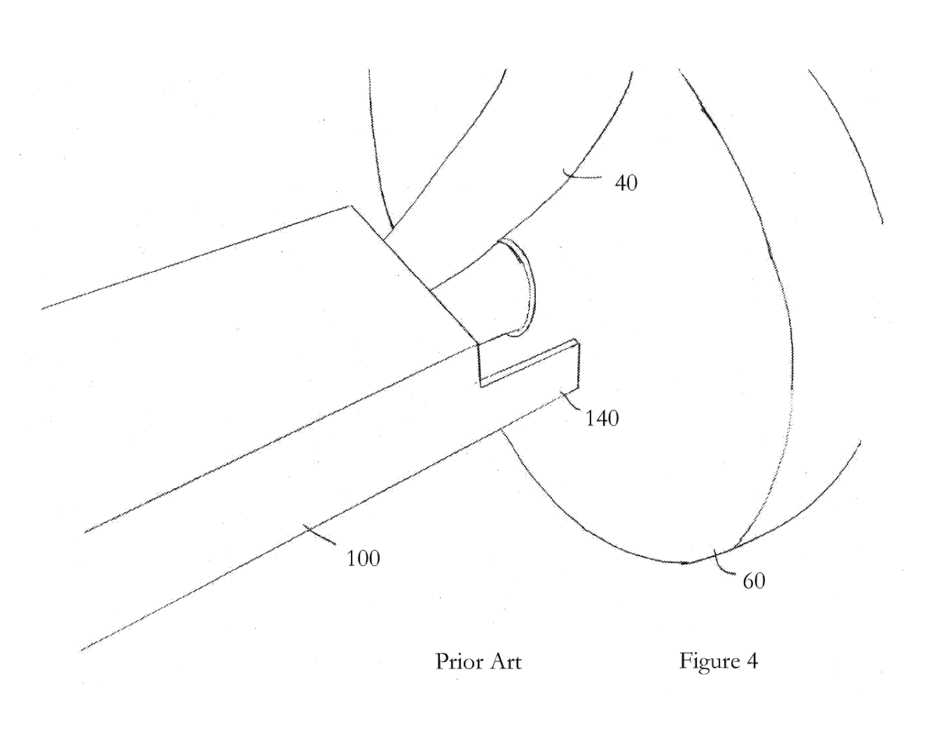

A close-up view of the stop member 130 is shown in FIG. 4. The frame 40 is shown, in this Figure, in the tipping position being at rest against the stop member 130 (not shown).

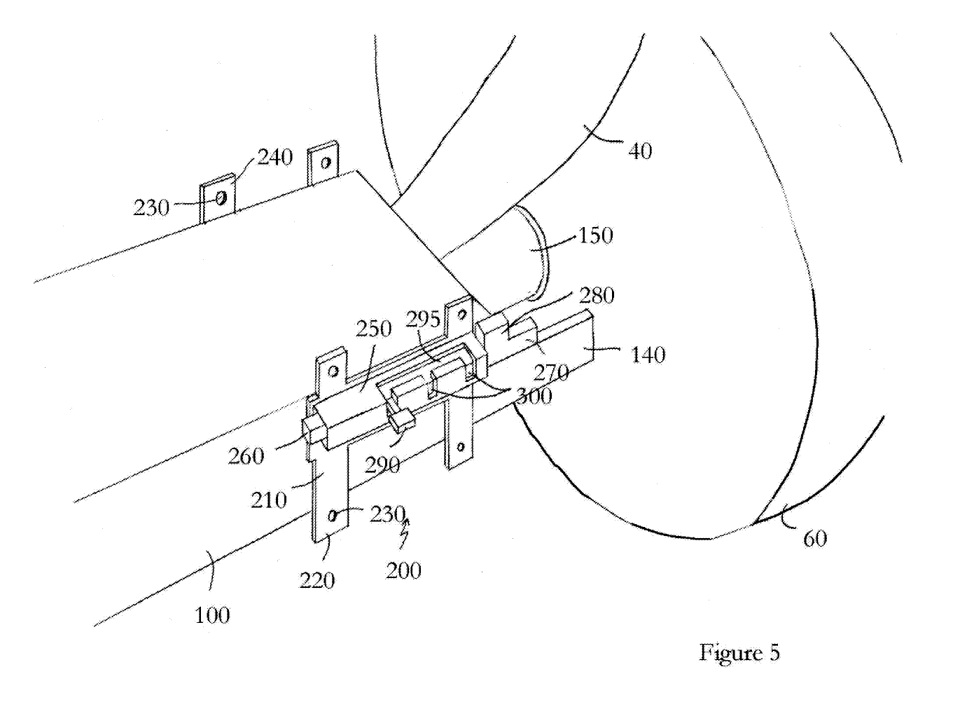

A similar view to that shown in FIG. 4 is shown in FIG. 5. However, in this Figure the adjuster 200 according to one embodiment of the invention is included.

The adjuster 200 comprises a back plate 210 which has four tabs 220. Each tab is provided substantially in each corner of the plate and includes a hole 230. The back plate 210 is placed adjacent and on one side of the support member 100. Another plate including tabs 240 with holes 230 is provided on the other side of the support member 100. Bolts (not shown) may be used to clamp the two plates around the support member 100 so as to retain the adjuster on the support member 100. The bolts (not shown) may pass through the holes 230 provided in the back plate 210 and other plate 240.

The back plate 210 includes a retaining member 250 which may take the form of a box-section tube. Other shaped tubes may be used. The retaining member 250 is open at each end and houses a cam carrier 260. The cam carrier 260 may be moved relative to the retaining member 250 by moving a tab 290 projecting perpendicularly from the cam carrier 260 at one point. The tab 290 may be used to rotate the cam carrier 260 relative to the retaining member 250. The retaining member 250 includes a slot 295 along which the tab 290 may be moved. The slot 295 extends linearly along the longitudinal length of the retaining member 250 and connects with three side slots 300 into which the tab may be moved to substantially lock the cam carrier 260 in position relative to the retaining member 250.

At one end of the cam carrier 260 two cam surfaces 270, 280 are provided. These cam surfaces 270, 280 take the form of projections located on the side of the cam carrier 260. One cam surface 270 has substantially the same cross-sectional size as the cam carrier 260. The other cam surface 280 has a greater cross-sectional size such that it projects perpendicularly from the longitudinal length of the cam carrier 260. They may be moved into a position whereby they occupy the space between the stop member 140 and the frame 40. The cam carrier 260 may be moved relative to the retaining member 250 such that either one of the cam surfaces 270, 280 is located between the stop member 140 and the frame 40. Alternatively, the cam carrier 260 may be moved relative to the retaining member 260 such that no cam surface is located between the stop member 140 and the frame 40. In this way, the distance between the frame 40 and the stop member 140 may be adjusted between three different positions. The presence of either one of the cam surfaces 270, 280 between the stop member 140 and the frame 40 allows for the frame 40, and thus the barrel 20, to be retained at different angles relative to the horizontal and thus adjust the mixing angle. The mixing angle being defined as the angle between the rotation axis “A” (refer to FIG. 1) and the horizontal which is substantially parallel to the ground surface on which the barrel mixer is placed, when the barrel is in the mixing position.

Although not shown it will be understood that another adjuster 200 may be located at the other horizontal end of the support member 100 such that the frame 40 may be adequately supported by either of the cam surfaces 270, 280 as necessary and in the same manner as discussed above.

In FIG. 5, the cam carrier 260 is shown in the inactive position in that no cam surface occupies the space between the stop member 140 and the frame 40. In this way, the frame 40 will rest on the stop member 140 when in the mixing position.

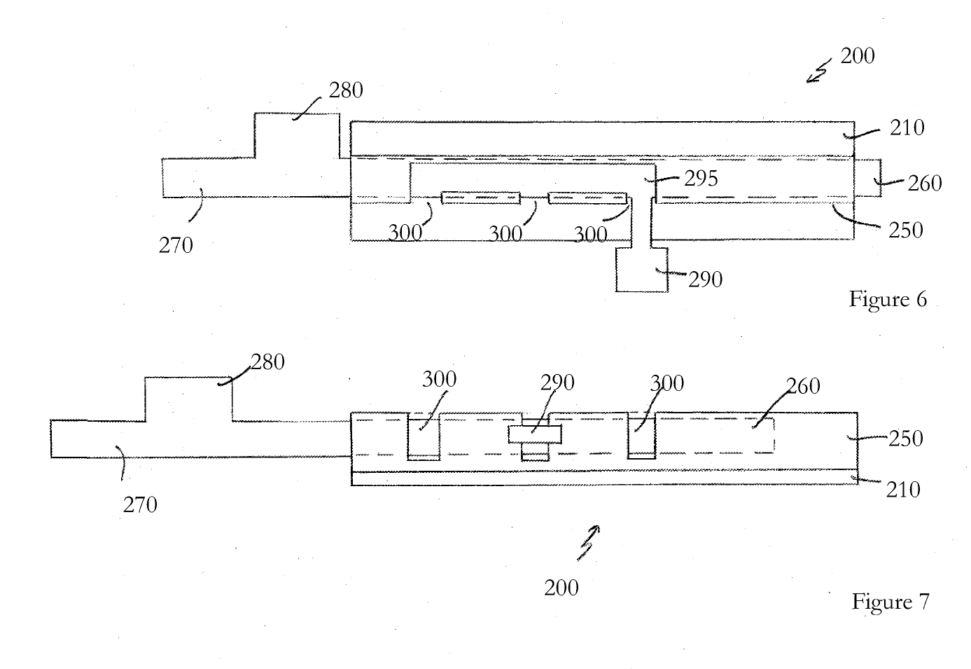

This is also the case in FIG. 6, where the cam carrier 260 is shown in the inactive position. This Figure provides a view of the adjuster 200 having a back plate 200 a retaining member 250 and a cam carrier 260. The outline of the cam carrier 260 is shown in broken lines where it is hidden from view by the retaining member 250. The tab 290 is shown in the side slot 300 which is located furthest from the longitudinal end of the cam carrier 260 at which the cam surfaces 270, 280 are provided.

The adjuster may be manufactured from mild steel or other suitable materials. In FIG. 6, the cam carrier 260 is shown in an active position in that it is shown extended longitudinally from the retaining member 250. In this configuration, the cam surface 270 would be located between the stop member 140 and the frame 40. The tab 290 is shown in the middle side slot 300. In this configuration, the mixing angle would be less than its maximum possible but greater than with the frame 40 resting directly on the stop member 140.

With the tab 290 in the side slot 300 nearest to the longitudinal end of the cam carrier 260 on which the cam surfaces 270, 280 are provided, the cam surface 280 would be located between the frame 40 and the stop member 140. In this configuration, the mixing angle would be at its greatest value.

The mixing angle, with no cam surface 270, 280 located between the stop member 140 and the frame 40 such that in a mixing position the frame 40 rests directly on the stop member 140, is approximately 25 degrees. This angle may be reduced to approximately 14 degrees with the cam surface 280 in the active position. The mixing angle may be approximately 19 degrees with the cam surface 270 in the active position. The cam surface 270 may act to increase the distance, with the barrel in the mixing position, between the frame 40 and the stop member 140 by approximately 8 mm. The cam surface 280 may act to increase the distance, with the barrel in the mixing position, between the frame 40 and the stop member 140 by approximately 15 mm. It will be apparent that other angles and distances are possible depending on the size and location of the cam surfaces 270, 280.

The adjuster 200 described above could be retro-fitted to an existing barrel mixer. Alternatively, they could be included as part of the manufacturing process. Although a back plate 210 and other plate have been described for use in clamping the adjuster 200 to an existing barrel mixer, other ways of attachment are contemplated such as welding, screwing and/or gluing. The adjuster 200 may be used in conjunction with, or in the absence of, the stop members 140 because it is possible to include other cam surfaces on the cam carrier 260 to act as the stop member 140 with the cam carrier in one position.

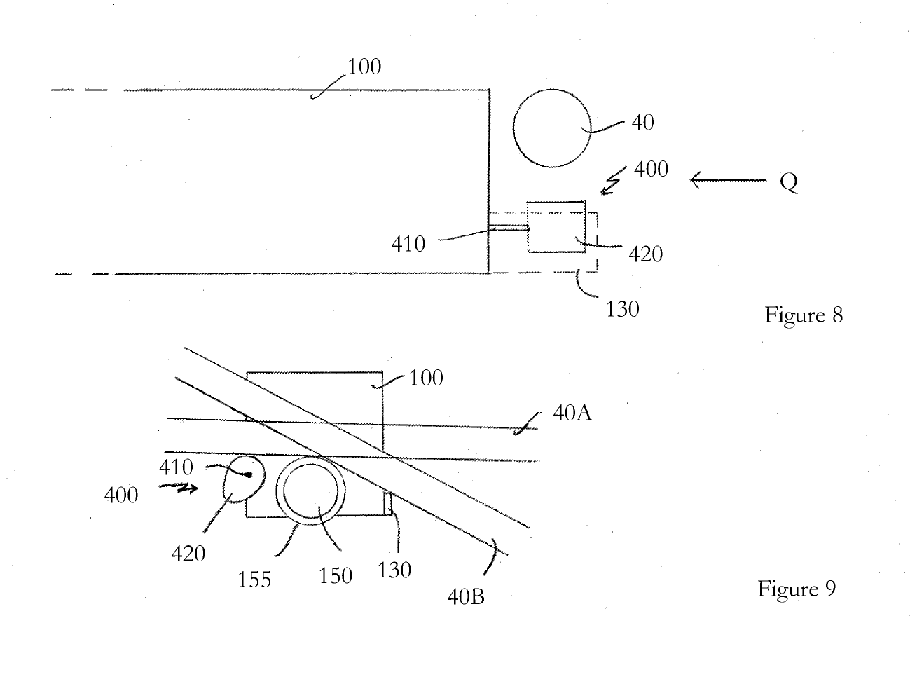

An alternative embodiment of an adjuster according to the invention is shown in FIGS. 8 to 10. In this embodiment, the adjuster 400 comprises an oval, or egg, shape member which is rotatably attached by an axle 410 to the support member 100. The axle 410 lies parallel to the length of the support member 100 and parallel to the axle 150. The adjuster 400 may replace the stop member 140. In FIG. 8 the stop member 140 is shown in broken lines to demonstrate how the oval shape member may replace the stop member 140. The view in FIG. 8 is from the rear of the barrel mixer 10 (i.e. with the mouth 30 of the barrel 20 on the opposite side, away from the viewer). Part of the frame 40 is shown although the lengths of the frame 40 which would extend upwardly and downwardly of the point of the frame 40 which rests on the stop member 140/adjuster 400 are not shown for the sake of clarity.

The frame 40 is shown in FIG. 8 with the barrel (not shown) in the tipping position with it spaced from the stop member 140/adjuster 400.

In FIG. 9, the view is along the direction of the arrow “Q” shown in FIG. 8. In this Figure, the frame 40 is shown in two different positions. In the first, frame 40A is shown with the barrel in the mixing position such that the frame 40A is resting on the adjuster 400. In the second, the frame 40B is shown in the tipping position with the frame 40B resting on the stop member 130.

The adjuster 400 is shown with the oval shape member 420 pivoted on axle 410. The axle 150 onto which the wheels 60 are attached is shown including the annulus 155 on which the frame 40 is rotatably attached to the axle 150.

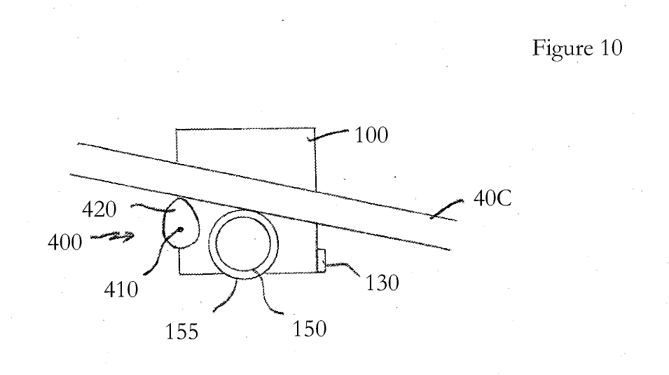

The oval member 420 may be rotated around the axle 410 allowing the adjustment of the mixing position. For instance, in FIG. 10, the oval member 420 has been rotated about its axle 410 such that the mixing position is different from that shown in FIG. 9. In this position, the mixing angle is reduced compared to that shown in FIG. 9. This is because the frame 40C now comes to rest at a different position due to the eccentric shape of the oval member 420.

The oval member 420 may be fixed at differing rotary positions such that the mixing angle is substantially infinitely variable between two extremes. Although the way in which the oval member is fixed in position relative to its axle 410 is not shown it would be relatively straight forward for the skilled person to produce. For example, a friction member or brake could be introduced to restrict rotation of the oval member 420.

By being able to adjust the mixing angle the type and quantity of materials and water used in the ingredients may be varied without risk of them not being properly mixed together to form a homogenous product. Also, by reducing the mixing angle the barrel may be washed out more easily. This is because to wash out a barrel water and sometimes bricks or other such items are placed in it and the barrel rotated for a period of time. However, if the mixing angle is too great then the front (near the mouth) of the barrel is not washed. By being able to reduce the mixing angle the front as well as the rear of the barrel may be effectively washed.

1. A barrel mixer comprising a barrel mounted on a frame, a base for supporting the frame, the frame being removably attachable to the base, a motor for rotating the barrel about a rotation axis for mixing of the barrel contents, a pivot for allowing movement of the barrel, relative to the base, between a mixing position and a tipping position, wherein the barrel mixer further comprises at least one adjuster for adjustably fixing the position of the barrel at selected points between the mixing and tipping positions.

2. The barrel mixer of claim 1, wherein the frame is pivotably attachable to the base.

3. The barrel mixer of claim 1, wherein the frame includes a support member and the frame is at least partially pivotable about the support member between the mixing and tipping positions.

4. The barrel mixer of claim 3, wherein the movement of the frame about the support member is limited by at least one stop member.

5. The barrel mixer of claim 1, wherein the at least one adjuster comprises at least one cam surface and a controller for moving the at least one cam surface between an active position and an inactive position.

6. The barrel mixer of claim 5, wherein in an active position the at least one cam surface lies between the at least one stop member and the frame such that a distance between the at least one stop member and the frame is substantially maintainable with the barrel in the mixing position.

7. The barrel mixer of claim 5, wherein the at least one adjuster comprises at least two different cam surfaces, having different dimensions from one another, and in an active position any one of the at least two cam surfaces lies between the at least one stop member and the frame such that the distance between the at least one stop member and the frame, with the barrel in the mixing position, is substantially maintainable dependent on which of the at least cam surfaces is in the active position.

8. The barrel mixer of claim 5, wherein the at least one cam surface is provided on a cam carrier, the cam carrier being slidably receivable in a retaining member, the retaining member being mounted on one of the support member and the frame.

9. The barrel mixer of claim 8, wherein the at least one cam surface is movable from the active position to the inactive position by means of sliding the cam carrier relative to the retaining member.

10. The barrel mixer of claim 6, wherein the at least one cam surface is provided by an ovoid member which is at least partially rotatable such that, in an active position, the distance between the at least one stop member and the frame is adjustably maintainable with the barrel in the mixing position.

11. The barrel mixer of claim 6, wherein the distance maintainable between the frame and at least one stop member with the barrel in the mixing position lies in the range 1 mm to 25 mm.

12. The barrel mixer of claim 6, wherein the distance maintainable between the frame and at least one stop member with the barrel in the mixing position lies in the range 5 mm to 15 mm.

13. The barrel mixer of claim 6, wherein the distance maintainable between the frame and at least one stop member with the barrel in the mixing position is either 8 mm or 15 mm.

14. The barrel mixer of claim 1, wherein the base is configured for disassembly and for fitting inside the drum when disassembled.

15. The barrel mixer of claim 14, wherein the base comprises a set of relatively slender legs.

16. A barrel mixer adjuster for use with a barrel mixer of the type comprising a barrel mounted on a frame, a base for supporting the frame, a motor for rotating the barrel about a rotation axis for mixing of the barrel contents, a pivot for allowing movement of the barrel, relative to the base, between a mixing position and a tipping position, wherein the adjuster, in use, adjustably maintains the position of the barrel at selected points between the mixing and tipping positions.

17. The barrel mixer adjuster of claim 16, including an attachment for removably attaching the adjuster to a barrel mixer.

18. The barrel mixer adjuster of claim 17, wherein the attachment comprises a clamp for clamping about a part of the barrel mixer.

19. A method of adjustably fixing the position of a barrel of a barrel mixer at selected points between a mixing position and a tipping position comprising the steps of: providing a barrel mixer of the type comprising a barrel mounted on a frame, a base for supporting the frame, a motor for rotating the barrel about a rotation axis for mixing of the barrel contents, a pivot for allowing movement of the barrel, relative to the base; providing an adjuster mounted, or for mounting, on the barrel mixer; operating the adjuster to adjustably fix the position of the barrel at selected points between the mixing position and the tipping position.
